(19) United States
(12) Patent Application Publication
(10) Pub. No.: US 2002/0133535 A1
(43) Pub. Date: Sep. 19, 2002

(54) Identity-centric data access

(75) Inventors: Mark Lucovsky, Sammamish, WA (US); Shaun D. Pierce, Sammamish, WA (US); Alexander T. Weinert, Seattle, WA (US); Michael G. Burner, Redmond, WA (US); Richard B. Ward, Redmond, WA (US); Paul J. Leach, Seattle, WA (US); George M. Moore, Issaquah, WA (US); Arthur Zwiegincew, Bothell, WA (US); Vivek Gundotra, Tustin, CA (US); Robert M. Hyman, Sammamish, WA (US); Jonathan D. Pincus, Bellevue, WA (US); Daniel R. Simon, Redmond, WA (US)

Correspondence Address: WORKMAN, NYDEGGER & SEELEY, A PROFESSIONAL CORPORATION, 1000 EAGLE GATE TOWER, 60 EAST SOUTH TEMPLE, SALT LAKE CITY, UT, 84111, US

(73) Assignee: Microsoft Corporation

(21) Appl. No.: 10/003,750

(22) Filed: Oct. 22, 2001

Related U.S. Application Data
(60) Provisional application No. 60/275,809, filed on Mar. 14, 2001.

(51) Int. Cl. G06F 15/16; G06F 7/00

(52) U.S. Cl. 709/201; 707/10

(57) ABSTRACT

A model for accessing data in an identity-centric manner. An identity may be a user, a group of users, or an organization. Instead of data being maintained on an application-by-application basis, the data associated with a particular identity is stored by one or more data services accessible by many applications. The data is stored in accordance with a schema that is recognized by a number of different applications and the data service. When a user is to perform an operation on the identity's data, the corresponding application generates a message that has a structure that is recognized by the data service. The message represents a request to perform an operation on the data structure corresponding to the identity. The data service receives and interprets the message. If authorized, the data service then performs the operation.

### CROSS-REFERENCE TO RELATED APPLICATION

The present application claims priority from co-pending U.S. provisional application serial No. 60/275,809, filed Mar. 14, 2001 and entitled “Identity-Based Service Communication Using XML Messaging Interfaces”, which provisional application is incorporated herein by reference in its entirety.

### BACKGROUND OF THE INVENTION

1. The Field of the Invention

The present invention relates to the field of data access technologies. Specifically, the present invention relates to maintaining and providing access to data in a user or identity-centric manner rather than in an application-centric manner.

2. Background and Related Art

The Internet has revolutionized the way people access information. With the aid of a conventional Internet-enabled computing device, one may obtain information on almost any subject with relatively little effort. Information is so abundant, that our ability to manage such information is often overwhelmed.

However, information is often irrelevant to all but a few. Some information is specific to only a single identity such as a person, group of people or organization. Such information may include, for example, addresses, telephone numbers, contacts, task lists, journals, schedules, grocery lists, music favorites and other preferences.

In order to manage such identity-specific information, a data access model 100 was developed as illustrated in FIG. 1. The data access model 100 include three fundamental components; an identity 110, an application 120, and data 130. The application 120 manages data 130 that the application 120 needs to operate properly. The data 130 typically includes identity-specific data as well as other types of data. During operation, the application 120 typically performs various operations on the data 130 either on its own initiative, or in response to instructions issued by the identity 110 or another program module.

The bi-directional arrow 140 represents a strong logical coupling between the application 120 and the data 130. Although the data 130 may include identity-specific data, the data 130 may be accessed only through the application that manages the data. For example, a Web-based grocery service application may manage a grocery list for an individual, store a residence address for delivery of the groceries, and store credit card information for automatic payment. All of this data is identity-specific. However, the data is accessed only through the Web-based grocery service application Likewise, a calendar application may maintain schedule information for a given identity. This calendar data is accessed via the calendar application only.

FIG. 2 illustrates this principles by extending the model of FIG. 1 to include multiple application programs, each interacting with their own data. For example, in addition to using application 120, the identity 110 also interfaces with applications 221 through 224. Each application 221 through 224 interacts with their own data 231 through 234, respectively. While there may be considerable redundancy between the data represented by data 130 and 231 through 234, each set of data is maintained and accessed via its own corresponding application.

Although functional, maintaining data on a per-application basis has disadvantages. Namely, if an application is no longer available, the corresponding data is often lost. For example, if an individual wanted to change Web-based grocery services, the individual would typically have to reenter the grocery list and the delivery address to a new Web-based application. Also, suppose a calendar application maintained schedule information in a proprietary format. In order to change from that calendar application, a user may have to reenter the calendar information for the next application.

In addition, since the application maintains the data, the user must access the data via the application. If the application is not mobile, the data is not mobile either, absent efforts to make the data redundant in multiple locations. Making the data redundant between applications often requires user effort to periodically synchronize the data. In addition, between synchronizations, the data sets in the different applications may diverge as the data changes. Sometimes, if the data diverges inconsistently in both applications, user intervention is required to resolve the inconsistencies. Accordingly, if the application is not mobile, the data is not mobile either without expending user effort.

Therefore, what is desired are methods, systems and computer program products for allowing identities more flexible access to and control over their corresponding identity-specific information regardless of the application.

### SUMMARY OF THE INVENTION

Methods, systems, and computer program products are described that facilitate more identity-centric data access. An identity may be a user, a group of users, an organization, an automated agent or proxy for a user or organization, or any other identifiable entity. Instead of data being maintained on an application-by-application basis, the data associated with a particular identity is stored by one or more data services accessible by many applications. Each data service may store a particular type of data for a number of identities. For example, there may be a calendar data service that stores calendar information for the identity, an in-box data service that stores received e-mails for the identity, and the like.

The data is stored in accordance with a schema that is recognized by a number of different applications and the data service. When a user is to perform an operation on the identity's data, the application that the user is interfacing with generates a message that has a structure that is recognized by the data service. The message represents a request to perform an operation on the data structure corresponding to the identity. The data service receives and interprets the message, and then determines whether or not to honor the request. For example, the data service may consult corresponding access control rules to determine if the application or user is authorized to perform the operation. An example of access control rules is an Access Control List or ACL. If authorized, the data service then performs the operation. The operation may include, for example deleting, updating, adding, or querying the data structure.

Any application that is authorized to perform an operation on an identity's data, and that structures a request message that is recognized by the service, may cause the requested operation to be performed on the identity's data. When an application needs to read the data, the application may read the data from the data service. When an application needs to write to the data, the application may write to the data service.

The identity may maintain control over which applications have what access to the data by altering the access control rules as desired. Thus, although the data may be maintained remotely, the data is still under the control of the identity. The identity may extend and revoke access privileges at will.

In one embodiment, the data service is implemented as a Web site or a Web service. However, the data service may also be implemented by a variety of connected computing devices. It is not essential to the invention the particular type of computing device or devices that implements the data service. Any connected devices may implement the data service such as personal computers, hand-held devices, multi-processor systems, microprocessor-based or programmable consumer electronics, network PCs, minicomputers, mainframe computers, and the like, or combinations thereof. Thus, any application that is authorized and capable may communicate with the Web site or service to access the data. This facilitates a wide variety of helpful scenarios. For example, a user may switch from one application on one device to another application on another device and still have access to the same data, without having to expend effort synchronizing or otherwise copying the data from one device to the other. Each application just accesses the identity's data via the data service instead.

Also, if a user subscribes to a new service, the user need not manually populate the new service with relevant identity-specific information such as name, address, telephone number, and the like. Instead, the user may simply generate a request to operate on the identity's data (specifically, the corresponding Access Control List) such that the application is then entitled to itself read the relevant identity-specific data, without requiring manual input.

Thus, the principles of the present invention provide an efficient model for accessing data on an identity-specific basis rather than having each application redundantly maintain its own data. Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 schematically illustrates a model that depicts the conventional relationship between an identity, an application, and data in accordance with the prior art in which there is a strong coupling between the application and the data;

FIG. 2 schematically illustrates the conventional model of FIG. 1 in which multiple applications interact with corresponding data on an application-by-application basis;

FIG. 3 schematically illustrates a model depicting the relationship between a user, an application, and data in accordance with the present invention in which there is a strong coupling between the identity and the data;

FIG. 4 schematically illustrates the model of FIG. 3 in which multiple applications interact with the same set of data;

FIG. 5 illustrates the model of FIG. 3 in which further details are illustrated for the data service that provides the data and the strong coupling between the identity and the data;

FIG. 6 is a flowchart of a method of performing operations on an identity's data with the identity's authorization in accordance with the present invention;

FIG. 7 is a flowchart of a structured method for determining an address of a user's data.

FIG. 8 schematically illustrates a data structure of a request that is in accordance with the message format recognized by the service and applications;

FIG. 9 illustrates a data object in which the meaning of the various fields of the data structure is understood by interpretation in light of a schemia;

FIG. 10 illustrates the structure of a service that responds to structured requests to perform data operations, and provides structured responses in accordance with the present invention;

FIG. 11 schematically illustrates a computing device that may implement the features of the present invention; and

FIG. 12 schematically illustrates a station that may perform centralized processing of communications between the applications and the services.

### DETAILED DESCRIPTION OF THE INVENTION

The present invention extends to methods, systems, and computer program products for accessing identity-specific data independent of the application accessing the data. Throughout this description and in the claims, an identity is defined as being a person, a group of people, an organization, or any other identifiable entity. Such identifiable entities may include, for example, a science project, a fundraising event, a word processing document, a power point presentation, a conference room, or an x-ray machine. However, this list is illustrative only, and not exhaustive. The model for accessing data includes three fundamental components; an identity, an application, and a data service. Rather than the application directly maintaining identity-specific data, the data service maintains the identity-specific data on behalf of the identity. Any of a number of applications may then access the data service to operate on the identity-specific data.

The embodiments of the present invention may comprise a special purpose or general purpose computing device including various computer hardware, as discussed in greater detail below. Embodiments within the scope of the present invention also include computer-readable media for carrying or having computer-executable instructions or data structures stored thereon. Such computer-readable media can be any available media which can be accessed by a general purpose or special purpose computer. By way of example, and not limitation, such computer-readable media can comprise physical storage media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. The claims may mention the term “computer program product.” In this description and in the claims, this term does not imply that the computer program product was bought for a price. The term “computer program products” may also include free products

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions. In this description and in the claims, a “network” is defined as any medium over which messages may be communicated. Thus, a network may include a medium for messaging between two different machines. However, a network may also be a mechanism for communicating messages between two processes running on the same machine.

Although not required, the invention will be described in the general context of computer-executable instructions, such as program modules, being executed by computing devices. Generally, program modules include routines, programs, objects, components, data structures, and the like that perform particular tasks or implement particular abstract data types. Computer-executable instructions, associated data structures, and program modules represent examples of the program code means for executing steps of the methods disclosed herein. The particular sequence of such executable instructions or associated data structures represent examples of corresponding acts for implementing the functions described in such steps.

Those skilled in the art will appreciate that the invention may be practiced in network computing environments with many types of computer system configurations, including personal computers, hand-held devices, multi-processor systems, microprocessor-based or programmable consumer electronics, network PCs, minicomputers, mainframe computers, and the like. The invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

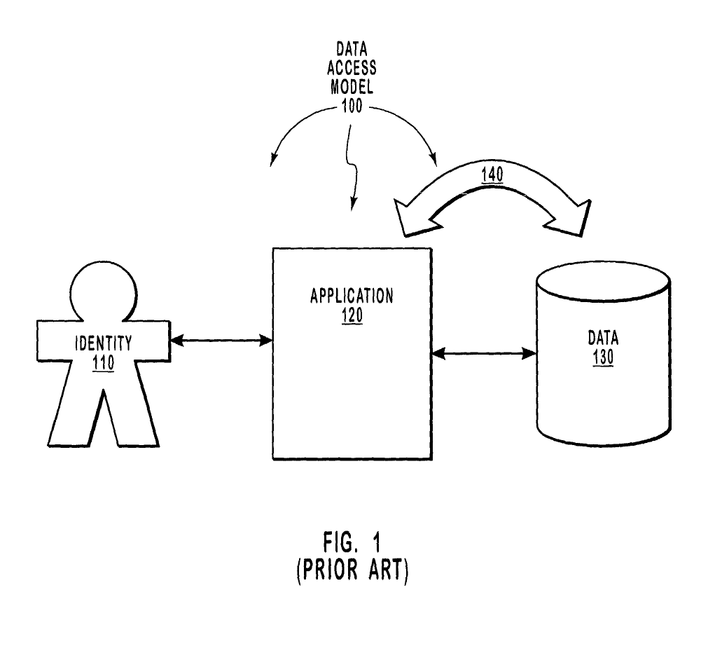

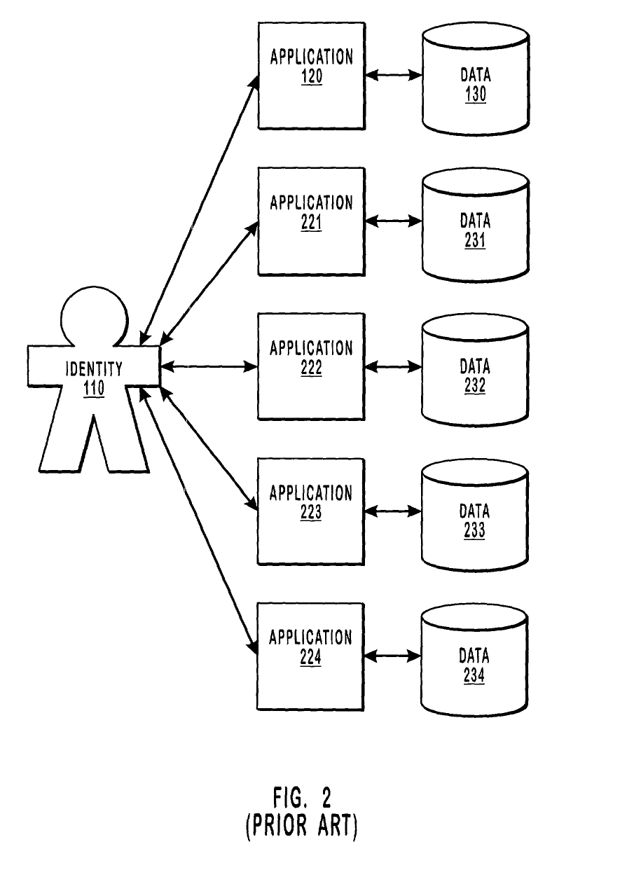

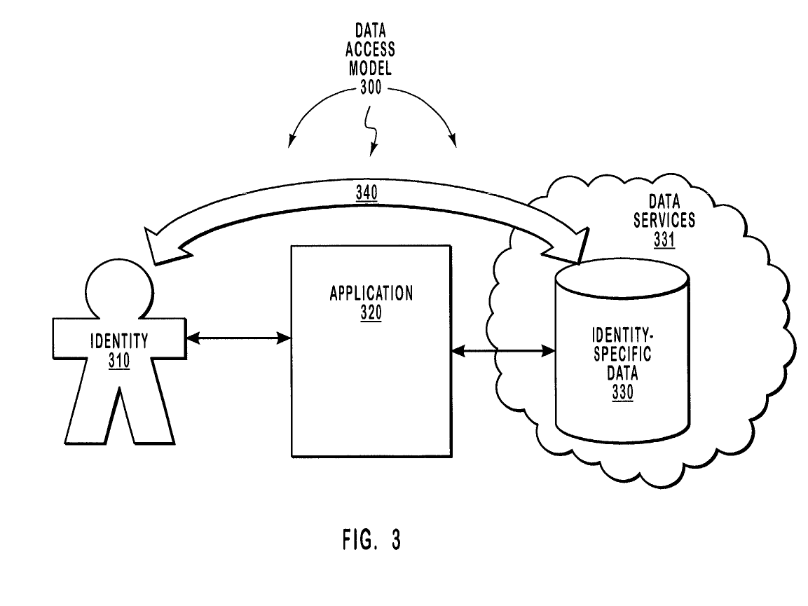

In contrast to the application-centric model for data access illustrated in FIGS. 1 and 2, the principles of the present invention allow an identity to have control over its identity-specific data independent of the application used to access the data. FIG. 3 schematically illustrates a model 300 for accessing data in accordance with the present invention. FIG. 3 may be contrasted with FIG. 1. The model includes an identity 310, an application 320, and a data services 331 that maintains identity-specific data 330. In contrast to arrow 140 of FIG. 1, an arrow 340 of FIG. 3 represents a strong coupling between the identity 310 and the identity-specific data 330.

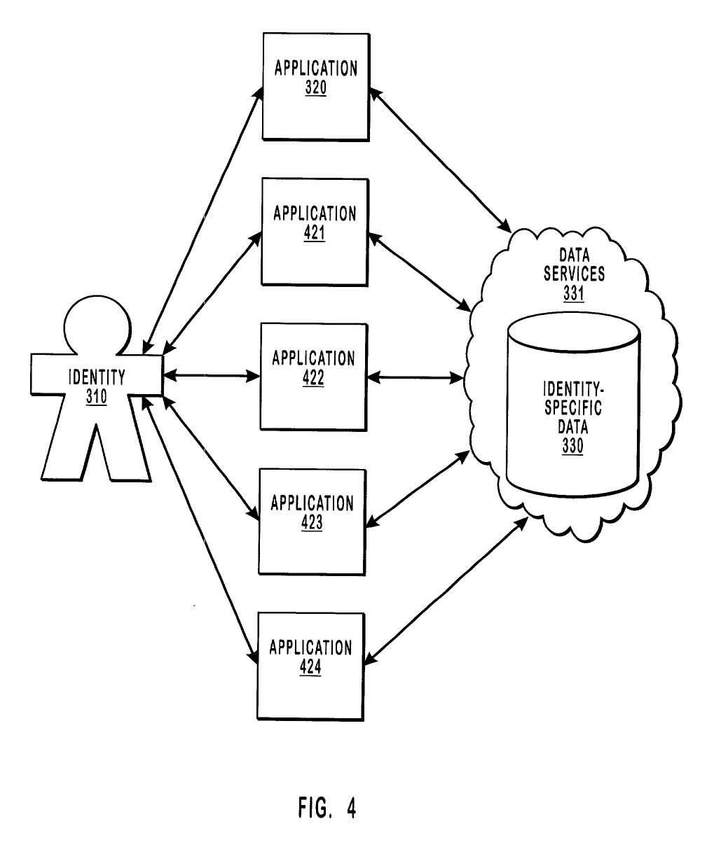

The data services 331 is represented by a cloud shape to emphasize that the data services 331 is accessible regardless of the application and device used so long as the application and device are capable of implementing the principles of the present invention. FIG. 4 illustrates this principle by showing the model of FIG. 3 in which the identity 310 accesses the identity-specific data 330 through multiple applications 320 and 421 through 424. FIG. 4 may be contrasted with FIG. 2. Instead of each application owning its own data, each application accesses the relevant identity-specific data from data services 331.

Although not required, the applications 320 and 421 through 424 may perform different functions and be implemented on different devices. For example, the identity 310 might use a desktop Personal Computer or “PC” running application 320 to draft a word processing document, and then move to a Personal Digital Assistant (hereinafter, “PDA”) that runs application 421 to continue editing. The identity may accomplish this even though the word processing applications locally represent the word processing document using incompatible data structures, and without having to synchronize the word processing document between the desktop PC and the PDA. From the identity's perspective, it is as though the identity 310 retrieves the word processing document from an ever-present and ever-accessible sky filled with all of the associated identity-specific data.

Not only may the identity access its own identity-specific data, but the identity may authorize other individuals and applications to perform specific operations on all or portions of the identity's data. For example, an identity may authorize a Web-based weather application to read, but not alter, the identity's address information to extract the zip code or town so that weather forecasts may be tailored to the identity. If the identity were to move, the identity would update the address information. Accordingly, the next time the identity runs the weather application, the weather application would provide a weather forecast specific to the new address. Thus, with just this authorization, the identity has avoided having to re-enter zip code information directly to the weather application. Many applications may benefit by avoiding this kind of manual entry of data using this kind of authorization. The weather application mentioned herein is just one example of such an application.

As another example, suppose that the identity is to sign up for a Web-based grocery delivery service. Instead of having to enter in the personal information and a grocery list, the identity may authorize the grocery delivery service application to have access to the address information as well as a grocery list for weekly delivery. The identity has avoided having to manually enter the information at the time it signed up for the service. Instead, the personal information and the grocery list were made accessible to the application through simple authorizations. Should the identity desire to switch Web-based grocery delivery services, the identity would retract authorizations granted to the previous application, and grant the same authorizations to the new application, thus again avoiding having to reenter the information.

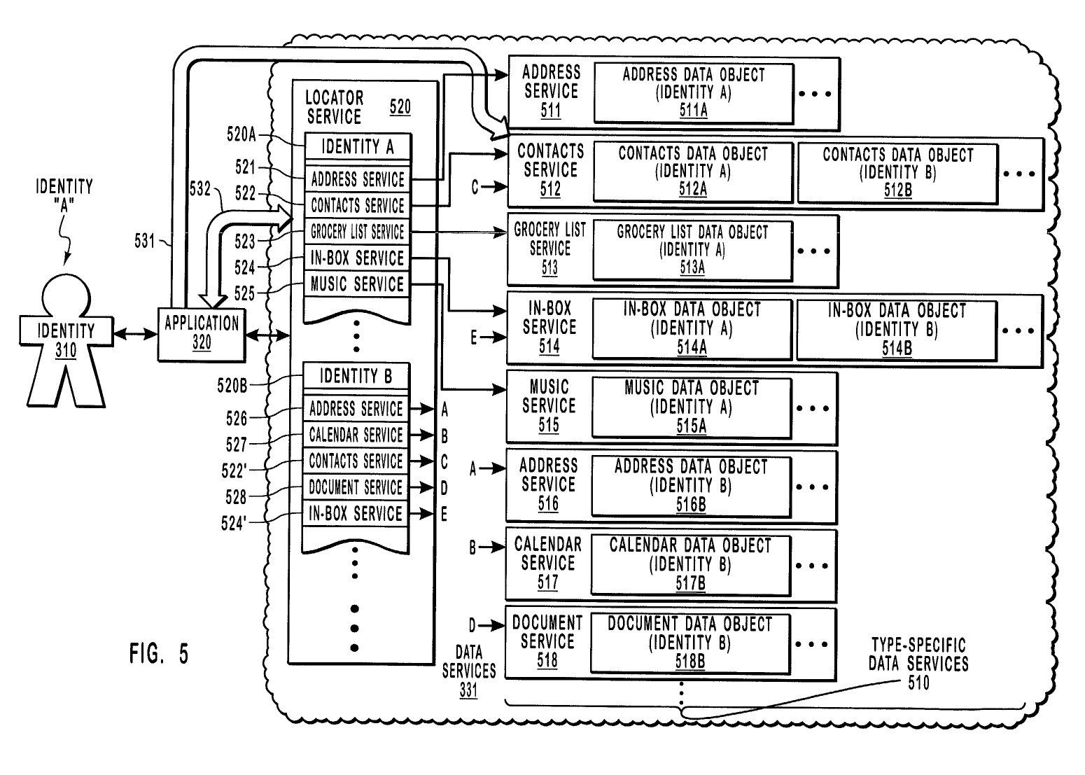

FIG. 5 shows more details regarding how the data access model 300 accomplishes this flexible organization and management of data on an identity-specific basis. The data services 331 includes a variety of type-specific data services 510 that manage identity-specific data in the form of data objects. Each service manages a specific type of data object for one or more identities. FIG. 9 illustrates the general format of such a data object. The data object 900 includes multiple fields including for example, field A 901, field B 902 and other fields 903.

The structure of the data object follows a specific set of rules or “schema” regarding where the fields are placed in a data structure, and the particular meaning of the fields. The schema may have an initial set of rules regarding the placement and meaning of an initial set of fields. However, the schema may also provide rules for adding more fields to the data structure, thus allowing flexibility in the amount and types of fields that a schema may support. Thus, the schema may be extensible. As long as an application follows the set of rules when interpreting the data object, the application will be able to interpret the meaning and content of the various fields within the data object. Thus, if a schema is widely recognized and followed, the data object may be interpreted by a wide variety of applications. In one embodiment, the data object is organized as an eXtenstible Markup Language (XML) document. XML documents are beneficial and capable of defining a data structure that follows a schema because XML provides for name-value pairing or “tags” where the meaning of the value may be implied by the name.

In the illustrated example, data objects are shown corresponding to an identity “A” and an identity “B”. However, it will be apparent that the principles of the present invention may be applied to allow identity-centric access for any number of identities.

Once again, the data services 331 may include many type-specific data services 510. For example, address service 511 manages an address data object 511A for identity A among others. The address data object may include information such as the corresponding identity's name, residence address, business address, home telephone number, work telephone number, fax number, mobile number, e-mail addresses, and the like. The address data object 511A is organized according to a specific schema that is followed by a number of applications. The data object 511A may be not in the clear as stored or transmitted. For example, the data object 511A may be encrypted or compressed, in which case decryption or decompression, respectively, may be necessary before the schematized structure may be discernable.

Proceeding down the list of type-specific data services 510, the contacts service 512 maintains a contacts data object 512A for identity A and a contacts data object 512B for identity B. The contacts data object may include contact information for individuals or organizations that the corresponding identity has interest in. The identity may have previously entered the contact information anticipating that such information might be useful in contacting the individual or organization. The contacts data object may also be organized according to a specific schema that may be recognized by multiple applications. The schema for the contacts data object may be different than the schema for the address data object since schemas are best organized when considering the nature of the underlying data type.

Proceeding further down the type-specific data services 510 is a grocery list service 513 that maintains a grocery list data object 513A for storing a grocery list associated with identity A. In addition, an in-box service 514 maintains an in-box data object 514A for received e-mails directed towards identity A, and an in-box data object 514B for received e-mails directed towards identity B. A music service 515 maintains a music data object 515A that stores music preferences for identity A. Another address service 516 maintains an address data object 516B for identity B. A calendar service 517 stores a calendar data object 517B corresponding to the schedule of identity B. A document service 518 maintains a document data object 518B for storing various documents that identity B is entitled to access

The type-specific data services 510 may also include many other types of type-specific data services as represented by the vertical ellipses in FIG. 5. For example, the type-specific data services may include a data service that maintains settings for various applications that are used by an identity, a data service that maintains a list of physical devices (and their capabilities) which associate with and interact with a given identity, a favorite Web site service that maintains a list of the identity's designated favorite Web sites, a location service that maintains a list of location-centric information about an identity, and the like.

For clarity, only an example list of type-specific data services has been mentioned. It will be apparent, in light of this disclosure, that the variety of type-specific data services is essentially unlimited. Each of the type-specific services maintains identity-specific data objects that follow a schema according to the type of data. In addition, there may be a number of type-specific services that maintain data structures of a particular type. For example, while address service 511 maintains identity A's address information, address service 516 maintains identity B's address information.

The type-specific data services 510 may be located anywhere in a network. However, in order to maximize availability, the type-specific data services 510 may be accessible via the Internet. Thus, the type-specific data services may be provided by a Web site and may be accessed via, for example, a World Wide Web address or other Uniform Resource Identifier (URI). As used in this description or in the claims, a Uniform Resource Identifier or URI is defined as any local or network addressing or naming mechanism and is broad enough to encompasses Globally Unique IDs (or GUIDs), Internet Protocol (IP) addresses, or yet to be developed addressing or naming mechanisms.

The number of type-specific data services 510 in the data services 331 may be quite large. In addition, the number of identities for which the data services 331 maintains identity-centric data may also be quite large. Accordingly, to assist in locating a particular type-specific data service corresponding to a particular individual, the data services 331 includes a locator service 520.

The locator service 520 organizes relevant type-specific data service addresses on an identity-specific basis. For example, the locator service 520 also maintains a data object 520A that represents a list of addresses corresponding to the type-specific data services that maintain identity A's data. For example, data object 520 includes the address service address 521, the contacts service address 522, the grocery list service address 523, the in-box service address 524, and the music service address 525. An arrow represents the logical addressing relationship where the address at the tail of the arrow is the address for the service at the head of the arrow.

The locator service 520 organizes such data objects for other identities as well. For example, a data structure 520B includes relevant addresses for identity B such as the address service address 526, the calendar service address 527, another instance of the contacts service address 522′, the document service address 528, and another instance of the in-box data service 524′. The addresses also point to the relevant type-specific data service. However, for clarity, the complete arrow is not shown for identity B. Instead, a corresponding letter A through E indicates the continuation of the arrow.

The address locator service 520 may also be located in any network. However, to facilitate availability yet again, the locator service 520 may be implemented on the Internet in the form of a Web site. In this case, the locator service 520 may be accessed via a World Wide Web address or other URI.

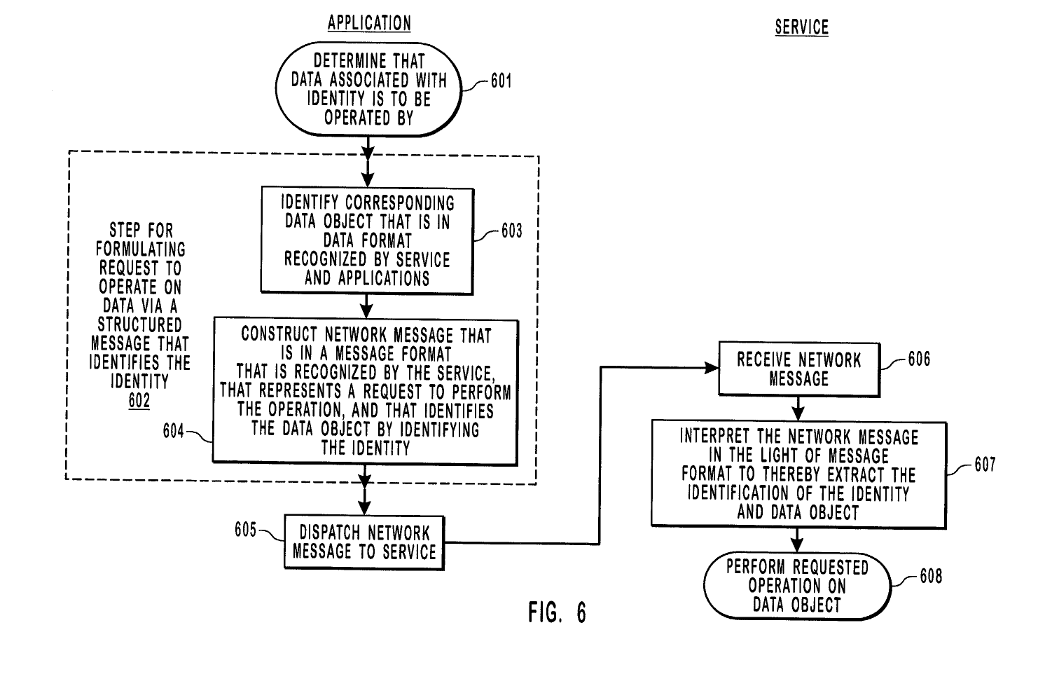

The identity 310, the application 320, and the data services 331 interact such that the data access model of FIG. 3 is emulated. This interaction is described with frequent reference to both FIG. 5 and FIG. 6, which illustrates a flowchart of a method of performing operations on an identity's data in accordance with the present invention.

Initially, the application 320 determines that data associated with the identity is to be operated on (act 601). In the normal course of operation, an application typically performs various operations on data. The scenarios in which data is operated upon and the types of operations performed depend heavily on the type of application. The principles of the present invention may be implemented with any application that needs to access data.

Next, the method performs a step for formulating a request to operate on the data via a structured network message that identifies the identity (step 602). In one embodiment, this includes specific corresponding acts 603 and 604. More particularly, the application identifies a data structure that represents the data associated with the identity (act 603). For example, if the application 320 is to add a new contact to identity A's contact data structure 320A, the application will uniquely identify the data structure using an identification of the identity (e.g., “identity A”) as well as an identification of the schema of the particular type-specific data object to be operated on (e.g., “contacts”).

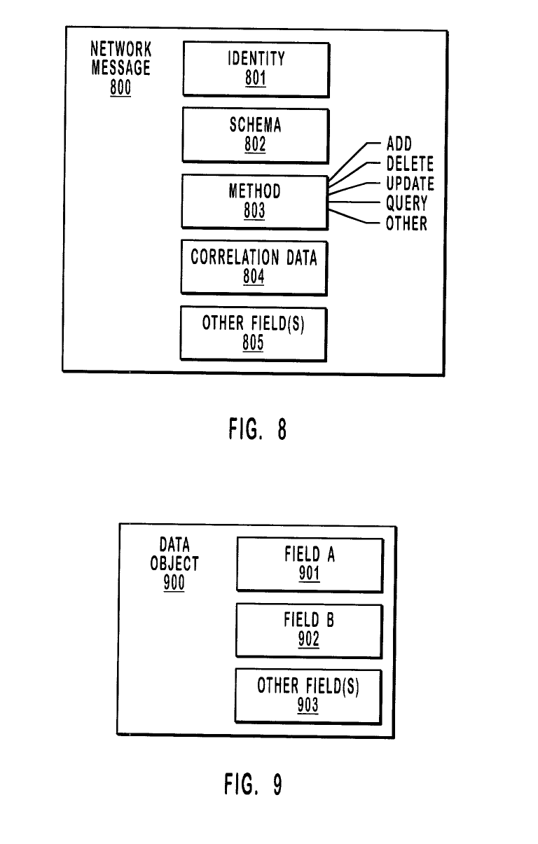

Next, the application constructs a network message in accordance with a message format that is recognized by the service (act 604). The network message represents a request to perform the operation on the data structure and may be structured as illustrated in FIG. 8 for network message 800. The network message 800 includes an identification of an identity 801 (e.g., “identity A”).

A type-specific data service may able to identify the appropriate data structure to operate on based on the identity alone. However, this may not always be the case. Accordingly, the network message 800 may also include an identification of the schema 802 associated with the data structure (e.g., “contacts”). For example, the application 320 may query the address locator 520 for the address corresponding to identity A's contacts data object. In this case, the address locator 520 might need to know the schema of the service desired. Otherwise, the address locator 520 might not know whether to return the address for identity A's contacts service, or whether to return an address corresponding to some other type-specific data service associate with identity A. On the other hand, if the network message is dispatched directly to the contact service associated with identity A, it may be implied that the requested operation is to be performed on a contacts data structure. In other words, the destination address of the network message may itself imply the schema.

The network message 800 also includes a method field 803 whereby the requested operation type may be specified. For example, such operations might include add, delete, query, update or other operations that allow for reading from and writing to the corresponding data object.

The network message 800 might also include a correlation data field 804. The correlation data permits applications to recognize that a particular incoming message represents a response to a particular outgoing request message. Some protocols such as HyperText Transport Protocol (HTTP) are a request/response protocol in which the correlation data is maintained by the transport protocol itself. However, other protocols such as Simple Mail Transfer Protocol (SMTP) are not request/response oriented.

In order to facilitate communication over a wide variety of protocols, the network message 800 may expressly state the correlation data 804. For example, the correlation data 804 may represent a message identification that uniquely identifies the message to the application 320. The network message 800 may also include other fields 805. More regarding how such a network message may be structured is described in the commonly-owned, co-pending United States application serial number [Attorney Docket No: 13768.198.2], filed on the same data herewith, and entitled “Messaging Infrastructure for Identity-Centric Data Access”, which application is incorporated herein by reference in its entirety.

In one embodiment, the network message is an XML document that is specifically structured in accordance with Simple Object Access Protocol or “SOAP”. SOAP specifies a structure or “SOAP envelope” of an XML document including a body portion as well as a header portion, but also allows for great flexibility in the type of headers and the type of content included in the body.

Returning to FIG. 6, the application 320 then dispatches the network message to the service (act 605). This may include forming the network message as the body of a transport protocol message. For example, the network message may be included in the body of an HTTP request, an SMTP message, or any other type of message transfer protocol or technique. The address of the service is specified in the transport level message for appropriate routing of the network message to the service.

Referring to FIG. 5, the service that receives the message may be the locator service 520 or one of the type-specific data services 510. Regardless of the service that receives the network message (act 606), the service interprets the network message in light of the message format to thereby extract the various fields of the network message 800 (act 607). The service then performs the requested operation on the data structure using the data format (608).

Returning back to FIG. 5, if the application 320 already has the address of the desired type-specific data, the application 320 may use the method of FIG. 6 to immediately dispatch a network message to the corresponding type-specific data service without having to query the locator service 520 for the address. This direct access is represent by arrow 531 in FIG. 5. For example, the application 320 may have previously acquired that address from the locator service 520, and stored the address locally.

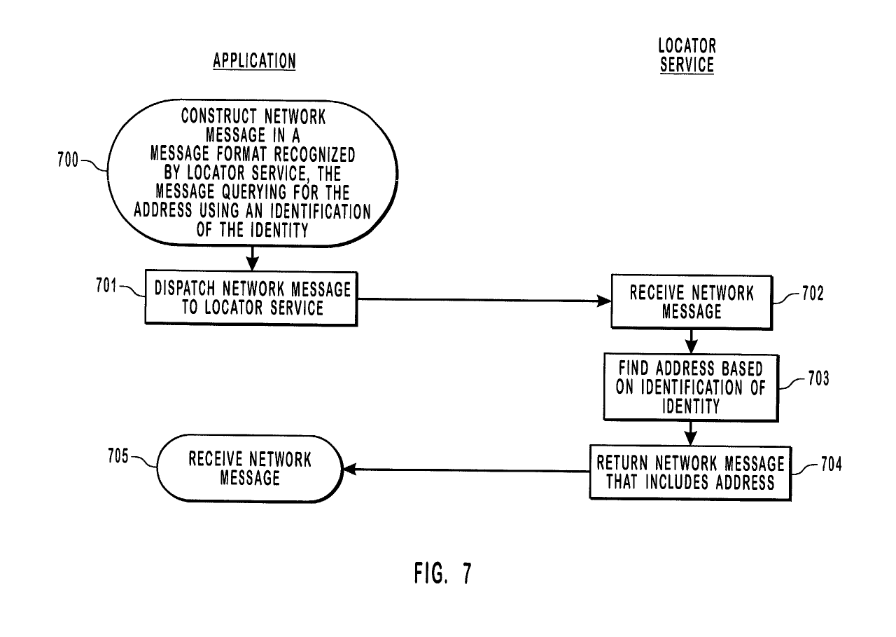

However, there may often be instances in which the application 320 is unaware of the address of the type-specific data service that the application 320 is to access. Accordingly, the application 320 may first query the locator service 520 for the address. The process of querying the locator service 520 is represented in FIG. 5 by bi-directional arrow 532 and by the flowchart of FIG. 7. Specifically, the application constructs a network message in accordance with the message format recognized by the locator service (act 700). The message represents a query for the address using an identification of the identity. The network message is then dispatched (act 701) and received by the locator service (act 702). The locator service then finds the address based on the identification of the identity (act 703). The locator service then returns a network message that includes the address (act 704) whereupon the message is received by the application (act 705).

If the schemas of the various type-specific data structures are recognized by a variety of applications, and if there is a wide variety of applications that may structure a network message in accordance with a message format recognized by the services, then the data need not be locally stored. Instead, any of a wide variety of applications may, with suitable modification to implement the principles of the present invention, be used to access the data. Thus, the identity may voyage from one application to the next, from one device to the next, and access the same data without fear of needing to attend to data inconsistencies or otherwise ensure that copies of the data are locally stored on multiple devices. From the identity's perspective, the identity (or its authorized representative) has access to the identity-owned data or any other authorized data at any time, at any place, and from any device.

Although the identity has access to the identity's own data, if it suits the identity's desires, the identity may choose to authorize that other identities or applications perform certain operations on certain portions of the identity's data. In order to allow the identity to maintain control over the identity's own data, this authorization may also be revoked as desired. In one embodiment, access privileges to a particular type-specific data structure for a given identity are maintained by the corresponding type-specific data service. In particular, the type-specific data structure has a “content” portion that represents the actual data, as well as an access control rules portion that defines which users have what rights to operate on what data. A particular example of access control rules used in this description is an Access Control List or ACL. Such access control rules may also be referred to as “role lists”. However, it will be apparent that the present invention is not limited to any particular type of access control rule. The network message may also include an identification of a requestor if other than the identity whose data is being operated upon. The type-specific service may then consult the access control rules to determine whether the request to operate on the data should be granted.

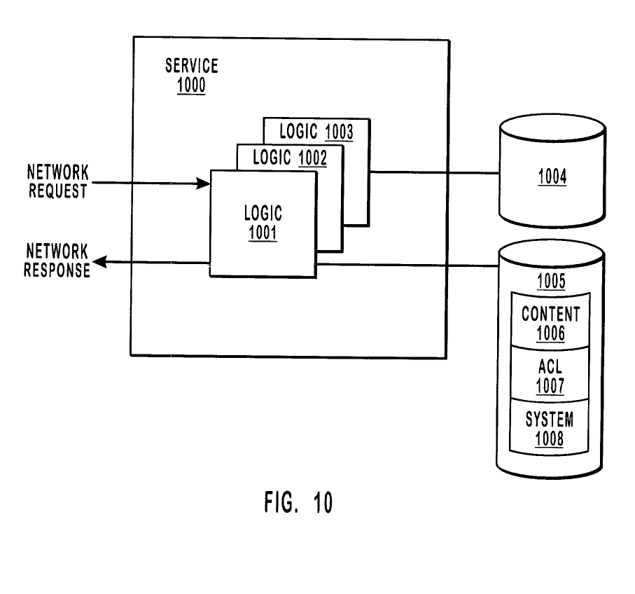

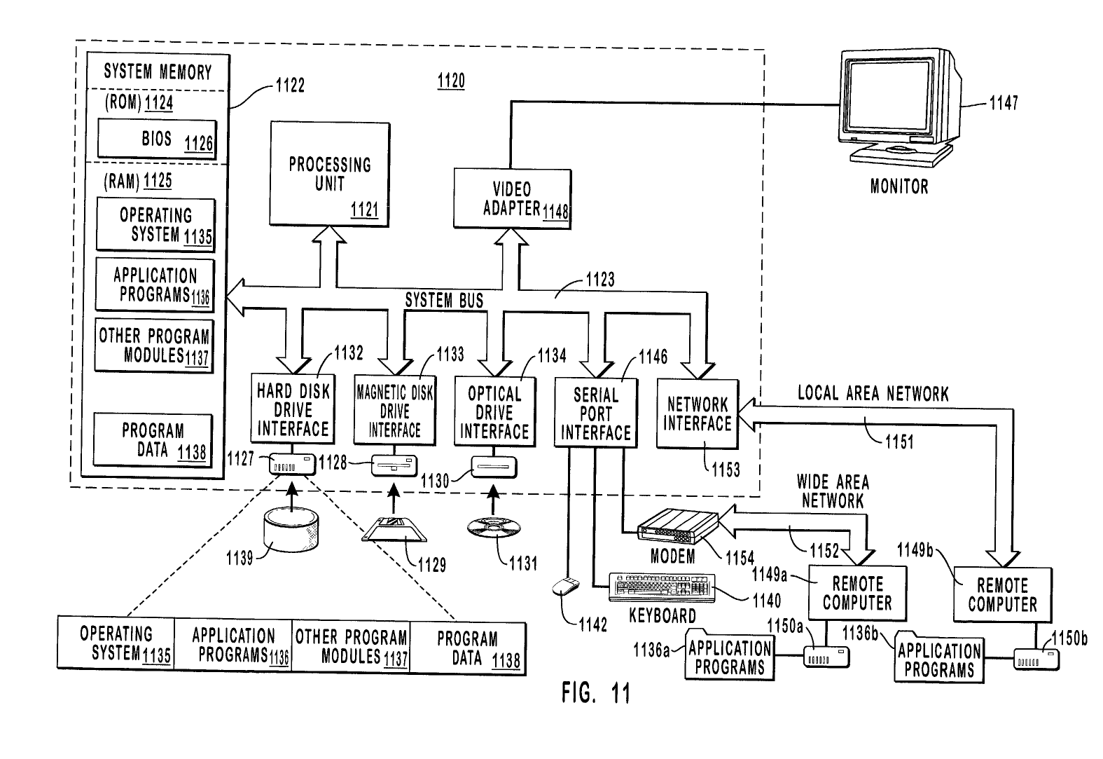

FIG. 10 schematically illustrates a structure of a service 1000 that may accomplish this. Specifically, the service may include one or more logic modules 1001, 1002, and 1003 that manage access to one or more memory components 1004 and 1005. Memory 1005 is illustrated as storing content data 1006, ACL data 1007, and system data 1008. Each data structure may have content, an ACL, and system data. Thus, the network message may also include an identification of which portion (content, ACL, or system) the requester desires to perform the operation upon. The identity may then request modifications to the ACL to ensure that other desired identities and applications are given at least limited access to the identity's data.

In this manner, convenient data sharing may be enabled. For example, the user may draft a document, store the document in the user's document service, and then share the document with a remotely located partner by submitting a command to appropriately alter the ACL of the corresponding document data structure. The remotely located partner may then use a local device to perform authorized operations on the document.

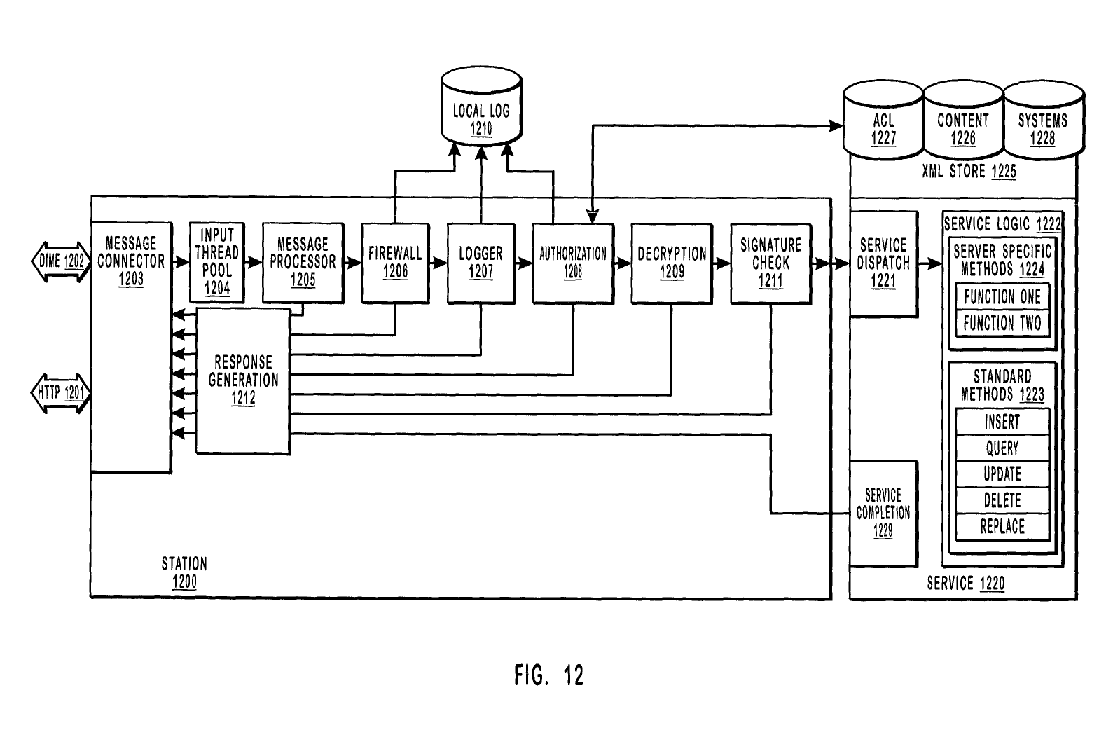

In one example embodiment, all of the requests are filtered through a centralized station that consolidates and performs functions that are common to each of the services. FIG. 12 illustrates a more specific diagram of the station 1200 and one of the services identified as service 1220. The station 1200 receives a request from an application using a network protocol such as HyperText Transport Protocol (HTTP) represented by arrow 1201, or Direct Internet Message Encapsulation (DIME) represented by arrow 1202. The station 1200 includes a message connector 1203, which receives the request and passes the message up the protocol stack so that the request may be further processed. The request is then provided to an input thread pool 1204 for temporary storage.

The request is then parsed at a message processor 1205, which parses the request into various components. For example, in one embodiment, the request is a Simple Object Access Protocol (SOAP) message in which case the message processor 1205 parses using the appropriate SOAP protocol. The message processor 1205 may also perform some preliminary level of rule checking to make sure the request should be further processed. For example, if the request is to manipulate a data structure that none of the services manage, the message processor 1205 may abstain from passing the request further down the process flow, and instead simply generate an error message using the response generation module 1212 to be returned via the message connector 1203.

The request may then be filtered by a firewall 1206 and then logged using a logger 1207. A firewall may also reject a request and generate an error message using the response generation module 1212 that is returned as a response via the message connector 1203. A local log 1210 may receive and store event information received from the firewall 1206, as well as normal logging information received from the logger 1207 such as the following for each received request: time received, method type, attribute types, and address of request. Then, an authorization module 1208 determines if the request is authorized to perform the requested operation on the target data structure. If authorization fails, then an error message is returned via the response generation module 1212 and the message connector 1203. Then authorization module 1208 may consult the ACL database 1227.

In one example, the request is in the form of an SOAP envelope, which contains unencrypted header information, as well as an optional encrypted body portion. A decryption module 1209 decrypts the body of the request. Then, a signature checker 1211 checks any signatures associated with the request to guard against tampering. Any failed decryption or signature checking may also be returned to the requester in the form of an error message generated by the response generation module 1212.

After signature checking, the station 1200 then passes information sufficient to accomplish the requested operation to the appropriate target service. This information includes a message that the request is authorized, the scope of access permissions, an identification of the requested method, and any needed request details.

The information is then passed to the service dispatch module 1221 of the service 1220. The service logic 1222 then receives and processes the information. The service logic 1222 is capable of perform standard methods 1223 including insert, query, update, delete, and replace as well as possibly some service specific methods 1224.

In order to execute the requested operation, the service logic accesses a data store that store the data structures to be manipulated. In one embodiment, the data structures to be operated upon are eXtensible Markup Language (XML) documents in which case the data store is an XML store 1225. The data structures to be accessed may be content documents 1226, ACL documents 1227 or system documents 1228.

Once the requested operation is performed on the target data structure using the service logic 1222 interacting with the XML store 1225, response information is provided to service completion module 1229. The response information is then passed to response generation module 1212 for generation of an appropriate response. The response is then returned to the user via the message connector 1203.

Having now described the principles of the present invention in detail, it is noted that the precise hardware configuration that implements the above-described features is not important to the present invention. For example, the locator service 520 may be implemented by one computing device or device cluster. In addition, a computing device or device cluster may implement groups of one or more of the other identity-based services such as those illustrated in FIG. 5. Also, the application 320 may be implemented on any device. Indeed, one of the unique features of the present invention is its lack of dependence on the hardware operating environment.

Nevertheless, for the sake of completeness, FIG. 11 illustrates an example computing system that may itself or in combination with other computing devices implement all or portions of the features described above. The example system includes a general purpose computing device in the form of a conventional computing device 1120, including a processing unit 1121, a system memory 1122, and a system bus 1123 that couples various system components including the system memory 1122 to the processing unit 1121. The system bus 1123 may be any of several types of bus structures including a memory bus or memory controller, a peripheral bus, and a local bus using any of a variety of bus architectures. The system memory includes read only memory (ROM) 1124 and random access memory (RAM) 1125. A basic input/output system (BIOS) 1126, containing the basic routines that help transfer information between elements within the computer 1120, such as during start-up, may be stored in ROM 1124.

The computer 1120 may also include a magnetic hard disk drive 1127 for reading from and writing to a magnetic hard disk 1139, a magnetic disk drive 1128 for reading from or writing to a removable magnetic disk 1129, and an optical disk drive 1130 for reading from or writing to removable optical disk 1131 such as a CD-ROM or other optical media. The magnetic hard disk drive 1127, magnetic disk drive 1128, and optical disk drive 1130 are connected to the system bus 1123 by a hard disk drive interface 1132, a magnetic disk drive-interface 1133, and an optical drive interface 1134, respectively. The drives and their associated computer-readable media provide nonvolatile storage of computer-executable instructions, data structures, program modules and other data for the computer 1120. Although the exemplary environment described herein employs a magnetic hard disk 1139, a removable magnetic disk 1129 and a removable optical disk 1131, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 1139, magnetic disk 1129, optical disk 1131, ROM 1124 or RAM 1125, including an operating system 1135, one or more application programs 1136, other program modules 1137, and program data 1138. For example, application 320 and the various data services may each be an application program such as application programs 1136.

A user may enter commands and information into the computer 1120 through keyboard 1140, pointing device 1142, or other input devices (not shown), such as a microphone, joy stick, game pad, satellite dish, scanner, or the like. These and other input devices are often connected to the processing unit 1121 through a serial port interface 1146 coupled to system bus 1123. Alternatively, the input devices may be connected by other interfaces, such as a parallel port, a game port or a universal serial bus (USB). A monitor 1147 or another display device is also connected to system bus 1123 via an interface, such as video adapter 1148. In addition to the monitor, personal computers typically include other peripheral output devices (not shown), such as speakers and printers.

The computer 1120 may operate in a networked environment using logical connections to one or more remote computers, such as remote computers 1149a and 1149b. Remote computers 1149a and 1149b may each be another personal computer, a server, a router, a network PC, a peer device or other common network node, and typically include many or all of the elements described above relative to the computer 1120, although only memory storage devices 1150a and 1150b and their associated application programs 1136a and 1136b have been illustrated in FIG. 11. The logical connections depicted in FIG. 11 include a local area network (LAN) 1151 and a wide area network (WAN) 1152 that are presented here by way of example and not limitation. Such networking environments are commonplace in office-wide or enterprise-wide computer networks, intranets and the Internet These networks may be the means whereby the network messages are communicated between the application 320 and the data services 331.

When used in a LAN networking environment, the computer 1120 is connected to the local network 1151 through a network interface or adapter 1153. When used in a WAN networking environment, the computer 1120 may include a modem 1154, a wireless link, or other means for establishing communications over the wide area network 1152, such as the Internet. The modem 1154, which may be internal or external, is connected to the system bus 1123 via the serial port interface 1146. In a networked environment, program modules depicted relative to the computer 1120, or portions thereof, may be stored in the remote memory storage device. It will be appreciated that the network connections shown are exemplary and other means of establishing communications over wide area network 1152 may be used.

Accordingly, the principles of the present invention allow for the convenient organization of data on an identity-centric basis. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed and desired to be secured by United States Letters Patent is:

1. In a computer environment including a plurality of applications that operate on data related to an identity, the computer environment also including a service that maintains data associated with the identity, a method for one of the plurality of applications to operate on data related to the identity, the method comprising the following:
an act of identifying a data structure that represents data that is to be operated on, the data being associated with the identity, the data structure being in accordance with a data format recognized by the service and the plurality of applications;
an act of constructing a network message in accordance with a message format that is recognized by the service, the network message representing a request to perform the operation on the data structure, the network message identifying the data structure by identifying the identity; and
an act of dispatching the network message to the service.

2. A method in accordance with claim 1, wherein the act of dispatching the network message to the service comprises dispatching the network message directly to the service without first communicating with a locator service.

3. A method in accordance with claim 1, wherein the data structure comprises a content data structure that represents the actual data of interest.

4. A method in accordance with claim 1, wherein the data structure comprises an access control data structure.

5. A method in accordance with claim 1, wherein the data structure comprises a systems data structure.

6. A method in accordance with claim 1, wherein the data that is to be operated on is not directly accessed by the plurality of application, but is only directly accessed via the service.

7. A method in accordance with claim 1, further comprising:
an act of the granting the application access to the data structure prior to the acts of identifying, constructing, and dispatching.

8. A method in accordance with claim 1, further comprising:
an act of revoking access from the application to the data structure after the acts of identifying, constructing, and dispatching.

9. A method in accordance with claim 1, further comprising the following:
an act of determining an address of the service.

10. A method in accordance with claim 9, wherein the act of constructing a network message comprises the following:
an act of including the address of the service in the network message.

11. A method in accordance with claim 9, wherein the network message is a first network message, wherein the act of determining an address of the service comprises the following:
an act of constructing a second network message in accordance with the message format that is recognized by a locator service, the second network message representing a query for the address using the identification of the identity;
an act of dispatching the second network message to the locator service; and
an act of receiving a response from the locator service that includes the address.

12. A method in accordance with claim 11, wherein the act of receiving a response from the locator service comprises the following:
an act of receiving a third network message from the locator service, the third network message being in accordance with the message format.

13. A method in accordance with claim 1, wherein the act of constructing a network message in accordance with a message format that is recognized by the service comprises the following:
an act of constructing a network message in accordance with the Simple Object Access Protocol.

14. A method in accordance with claim 1, wherein the act of dispatching the network message to the service comprises the following:
an act of dispatching the network request to a locator service that maintains a list of addresses for type-specific data services corresponding to the identity.

15. A method in accordance with claim 1, wherein the act of dispatching the network message to the service comprises the following:
an act of dispatching the network request to a type-specific data service that maintains a list of addresses for type-specific data services corresponding to the identity.

16. A method in accordance with claim 1, wherein the act of dispatching the network message to the service comprises the following:
an act of dispatching the network message to the service using a transport protocol that is compatible with transport over the Internet.

17. A method in accordance with claim 1, wherein the act of dispatching the network message to the service comprises the following:
an act of dispatching the network message to a different machine as compared to the machine that runs the application.

18. A method in accordance with claim 1, wherein the act of dispatching the network message to the service comprises the following:
an act of dispatching the network message to a service that is run on the same machine as the application.

19. A method in accordance with claim 1, wherein the identity is an individual.

20. A method in accordance with claim 1, wherein the identity is a group of individuals.

21. A method in accordance with claim 1, wherein the identity is an organization.

22. In a computer environment including a plurality of applications that operate on data related to an identity, the computer environment also including a service that maintains data associated with the identity, a method for one of the plurality of applications to operate on data related to the identity, the method comprising the following:
an act of determining that data associated with the identity is to be operated on;
a step for formulating a request to operate on the data via a structured network message that identifies the identity; and
an act of dispatching the network message to the service.

23. A method in accordance with claim 22, wherein the step for formulating a request comprises the following:
an act of identifying a data structure that represents the data associated with the identity, the data structure being in accordance with a data format recognized by the service and the plurality of applications; and
an act of constructing a network message in accordance with a message format that is recognized by the service, the network message representing a request to perform the operation on the data structure, the network message identifying the data structure by identifying the identity.

24. A computer program product for use in a computer environment including a plurality of applications that operate on data related to an identity, the computer environment also including a service that maintains data associated with the identity, the computer program product for implementing a method for one of the plurality of applications to operate on data related to the identity, the computer program product comprising one or more computer-readable media having stored thereon the following:
computer-executable instructions for identifying a data structure that represents data that is to be operated on, the data being associated with the identity, the data structure being in accordance with a data format recognized by the service and the plurality of applications;
computer-executable instructions for constructing a network message in accordance with a message format that is recognized by the service, the network message representing a request to perform the operation on the data structure, the network message identifying the data structure by identifying the identity; and
computer-executable instructions for causing the network message to be dispatched to the service.

25. A computer program product in accordance with claim 24, wherein the one or more computer-readable media are physical storage media.

26. A computer program product in accordance with claim 24, wherein the one or more computer-readable media further have stored thereon the following:
computer-executable instructions for constructing a second network message in accordance with the message format that is recognized by a locator service, the second network message representing a query for the address using the identification of the identity;
computer-executable instructions for causing the second network message to be dispatched to the locator service; and
computer-executable instructions for detecting the receipt of a response from the locator service that includes the address.

27. In a computer environment including a plurality of applications that operate on data related to an identity, the computer environment also including a service that maintains data associated with the identity, a method for the service facilitating access of the plurality of applications to data related to the identity, the method comprising the following:
an act of receiving a network message from one of the plurality of applications, the network message structured in accordance with a message format that is recognized by the service, the network message representing a request to operate on a data structure associated with the identity, the data structure being structured in accordance with a data format recognized by the service and the plurality of applications;
an act of interpreting the network message in light of the message format to thereby extract an identification of the identity and an identification of the data structure; and
an act of performing the requested operation on the data structure using the data format.

28. A method in accordance with claim 27, further comprising the following:
prior to the act of performing the requested operation, an act of determining that the one of the plurality of applications is authorized to perform the requested operation on the data structure.

29. A method in accordance with claim 28, wherein:
the method further comprises an act of maintaining a list of access rights to the data structure; and
the act of determining that the one of the plurality of applications is authorized to perform the requested operation on the data structure comprises an act of referring to the list of access rights.

30. A method in accordance with claim 29, wherein the act of maintaining a list of access rights to the data structure comprises an act of honoring requests issued by the identity to control access rights to the data structure.

31. A method in accordance with claim 27, wherein the data structure represents addresses corresponding to a plurality of type-specific data services that maintain type-specific data structures related to the identity.

32. A method in accordance with claim 31, wherein network message is a first network message, wherein the act of performing the requested operation on the data structure comprises the following:
an act of reading at least one address from the data structure;
an act of constructing a second network message that includes the at least one address read from the data structure; and
an act of dispatching the second network message.

33. A method in accordance with claim 32, wherein the act of dispatching the second network message comprises an act of dispatching the second network message to the one of the plurality of application programs.

34. A method in accordance with claim 32, wherein the act of dispatching the second network message comprises an act of dispatching the second network message in accordance with the message format.

35. A method in accordance with claim 27, wherein the data structure represents personal address information corresponding to the identity.

36. A method in accordance with claim 27, wherein the data structure represents contacts information corresponding to the identity.

37. A method in accordance with claim 27, wherein the data structure represents grocery list information corresponding to the identity.

38. A method in accordance with claim 27, wherein the data structure represents in-box information corresponding to the identity.

39. A method in accordance with claim 27, wherein the data structure represents music service information corresponding to the identity.

40. A method in accordance with claim 27, wherein the data structure represents calendar information corresponding to the identity.

41. A method in accordance with claim 27, wherein the data structure represents documents that the identity is entitled to access.

42. A method in accordance with claim 27, wherein the data structure represents application setting information corresponding to the identity.

43. A method in accordance with claim 27, wherein the data structure represents physical device information corresponding to the identity.

44. A method in accordance with claim 27, wherein the data structure represents favorite Web site information corresponding to the identity.

45. A method in accordance with claim 27, wherein the network message is a first network message, wherein the act of performing the requested operation on the data structure comprises the following:
an act of reading at least one address from the data structure;
an act of constructing a second network message that includes the at least one address read from the data structure; and
an act of dispatching the second network message.

46. A method in accordance with claim 45, wherein the act of dispatching the second network message comprises an act of dispatching the second network message to the one of the plurality of application programs.

47. A method in accordance with claim 45, wherein the act of dispatching the second network message comprises an act of dispatching the second network message in accordance with the message format.

48. A computer-program product for use in a computer environment including a plurality of applications that operate on data related to an identity, the computer environment also including a service that maintains data associated with the identity, the computer program product for implementing a method for the service facilitating access of the plurality of applications to data related to the identity, the computer program product comprising one or more computer-readable media having stored thereon the following:
computer-executable instructions for detecting the receipt of a network message from one of the plurality of applications, the network message structured in accordance with a message format that is recognized by the service, the network message representing a request to operate on a data structure associated with the identity, the data structure being structured in accordance with a data format recognized by the service and the plurality of applications;
computer-executable instructions for interpreting the network message in light of the message format to thereby extract an identification of the identity and an identification of the data structure; and
computer-executable instructions for performing the requested operation on the data structure using the data format.

49. A computer program product in accordance with claim 48, wherein the one or more computer-readable media are physical storage media.

50. A computer program product in accordance with claim 48, wherein the one or more computer-readable media further comprise the following:
computer-executable instructions for determining that the one of the plurality of applications is authorized to perform the requested operation on the data structure prior to the performing the requested operation.

51. A computer program product in accordance with claim 48, wherein the one or more computer-readable media further have stored thereon the following:
computer-executable instructions for maintaining a list of access rights to the data structure; and
computer-executable instructions for referring to the list of access rights in order to determine that the one of the plurality of application is authorized to perform the requested operation on the data structure.

52. A computer network that facilitates access to identity-centric data, the computer network comprising the following:
a plurality of applications that operate on data related to an identity, each of the plurality of applications configured to determine that data associated with the identity is to be operated on, identify a data structure that represents the data associated with the identity, construct a network message in accordance with a message structure recognized by the plurality of applications, the network message representing a request to perform the operation on the data structure, the network message identifying the data structure by identifying the identity, and configured to dispatch the network message to the service; and
a plurality of services that maintain data associated with the identity, each of the plurality of applications configured to detect the receipt of the network message from one of the plurality of applications, interpret the network message in light of the message format to thereby extract an identification of the identity and an identification of the data structure, and perform the requested operation on the data structure using the data format.

53. A method for providing identity-centric data to one or more applications, the method including at least the following acts:
storing identity-centric data relating to multiple identities in a data store associated with a data service;
receiving various requests from the applications for identity-centric data relating to at least some of the identities; and
providing the requested data to the requesting applications in response to their requests.

54. A method for accessing identity-centric data via a data service which maintains identity-centric data relating to user identities, the method comprising:
requesting identity-centric data relating to one or more of the user identities from the data service, and
receiving the requested data from the data service.
